(19) United States
(12) Patent Application Publication
(10) Pub. No.: US 2004/0205007 A1
(43) Pub. Date: Oct. 14, 2004

(54) Systems and methods for identifying and tracking funeral containers

(76) Inventors: Andrew J. Curtis, Dallas, TX (US); Joehannah Curtis, Dallas, TX (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/410,774

(22) Filed: Apr. 10, 2003

(51) Int. Cl. G06F 17/60

(52) U.S. Cl. 705/28

(57) ABSTRACT

A method for identifying and tracking a plurality of funeral containers is provided. The method may include generating a plurality of identification numbers. The method may also include providing a database that may be used to uniquely associate each identification number in the plurality of identification numbers with one of the plurality of funeral containers. The method may also include sending the plurality of identification numbers to a funeral container manufacturer.

### TECHNICAL FIELD

The present invention relates generally to funeral containers. More specifically, the present invention relates to systems and methods for identifying and tracking funeral containers.

### BACKGROUND

As used herein, a “funeral container” is any structure that may be used to hold the remains of a deceased person. One example of a funeral container is a casket. A deceased person's body may be placed inside a casket, and the casket may then be buried in a cemetery. Another example of a funeral container is an urn. When a deceased person's body is cremated, the cremation remains may be placed inside an urn. The urn may then be placed in a location that will remind relatives and/or friends of their association with the deceased person. For example, an urn may be placed in a surviving family member's living room.

Presently, the funeral container industry consists primarily of funeral container manufacturers and funeral service providers. Funeral container manufacturers make and sell funeral containers. Funeral service providers provide funeral services for deceased individuals. Providing funeral services typically involves purchasing funeral containers from the funeral container manufacturers (either directly or through a distributor) and selling them to relatives and/or friends of the deceased individuals.

There are several problems with the funeral container industry as it currently stands. First, some funeral service providers may try to maximize profits by engaging in unscrupulous business practices. For example, a funeral service provider may sell an expensive funeral container to the relatives of a deceased person, but then use a much cheaper (though similar looking) funeral container to bury the deceased person. Presently, there is no system in place to prevent such deceptive tactics.

Another problem relates to determining where the remains of a deceased person are located. For example, sometimes a person dies and is buried without the knowledge of all of his or her relatives and friends. A relative or friend who was unable to attend the funeral may wish, at a later time, to visit the remains of the deceased person and pay his or her last respects. However, currently it may be difficult for such relatives or friends to find out where the remains of the deceased person are located.

Another problem relates to compiling information about the funeral container industry. There may be a number of individuals or organizations who are interested in compiling such information. For example, government agencies who have regulatory authority over the funeral container industry may be interested in compiling statistics regarding the number of funeral containers manufactured, the number of funeral containers purchased by funeral service providers, the number of funeral containers purchased by consumers, and so forth. However, currently it may be difficult to compile such information.

Accordingly, benefits may be realized if means were provided to address one or more of the above problems.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram of a system for identifying and tracking funeral containers;

FIG. 2 is a flow diagram illustrating an embodiment of a method for identifying and tracking funeral containers;

FIG. 3 is a flow diagram illustrating an alternative embodiment of a method for identifying and tracking funeral containers;

FIG. 4 is a block diagram illustrating an embodiment of a database;

FIG. 5 is a flow diagram illustrating an embodiment of a method for generating one or more identification numbers;

FIG. 6 illustrates an input screen from an embodiment of a database interface;

FIG. 7 illustrates another input screen from an embodiment of a database interface; and

FIG. 8 is a block diagram of hardware components that may be used in an embodiment of a computing device.

### DETAILED DESCRIPTION

It will be readily understood that the components of the embodiments as generally described and illustrated in the Figures herein could be arranged and designed in a wide variety of different configurations. Thus, the following more detailed description of the embodiments of the systems and methods of the present invention, as represented in the Figures, is not intended to limit the scope of the invention, as claimed, but is merely representative of the embodiments of the invention.

Several aspects of the embodiments described herein will be illustrated as software modules stored in a computing device. As used herein, a software module may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

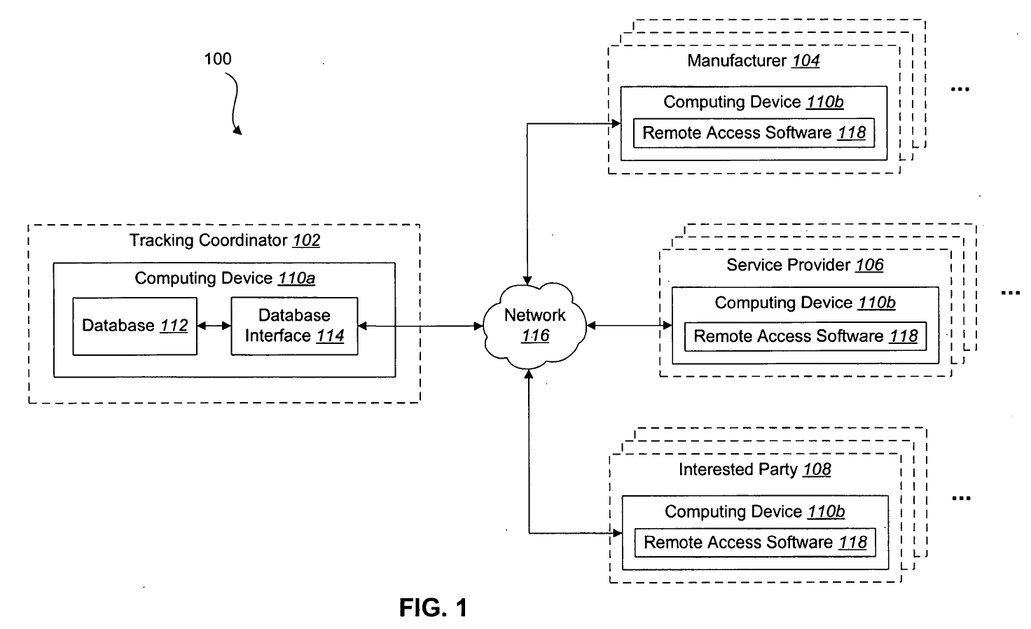

FIG. 1 is a block diagram of a system 100 for identifying and tracking funeral containers. The system 100 may include a funeral container tracking coordinator 102 (hereinafter, a “tracking coordinator”), one or more funeral container manufacturers 104 (hereinafter, “manufacturers”), one or more funeral service providers 106 (hereinafter, “service providers”), and one or more other interested parties 108. As described previously, the manufacturers 104 make and sell funeral containers. The service providers 106 provide funeral services for deceased individuals. Providing funeral services typically involves purchasing funeral containers from the manufacturers 104 (either directly or through a distributor) and selling them to relatives and/or friends of the deceased individuals. The tracking coordinator 102 assists the manufacturers 104 and service providers 106 to identify and track the funeral containers. The interested parties 108 are individuals who are interested in the information collected by the tracking coordinator 102.

The tracking coordinator 102, manufacturers 104, service providers 106, and interested parties 108 may each use a computing device 110 to help with their day-to-day operations. As used herein, a computing device 110 is any device that includes a digital processor capable of receiving and processing data. A computing device 110 includes the broad range of digital computers including personal computers, hand-held computers, servers, mainframes, supercomputers, microcontrollers, and the like. Computing devices 110 are known to those skilled in the art.

For purposes of clarity, the computing device 110 used by the tracking coordinator 102 will be referred to herein as a primary computing device 110a, and the computing devices 110 used by the manufacturers 104, service providers 106, and interested parties 108 will be referred to herein as secondary computing devices 110b. However, the terms “primary” and “secondary” are used for identification purposes only, and should not be construed to suggest anything about the computing devices 110 themselves.

The primary computing device 110a may include a database 112. The database 112 may be a software module, as that term is described above. In general terms, the database 112 is a collection of data organized in such a way that the data may be searched, retrieved, and/or updated. Additional details about the configuration and operation of various embodiments of the database 112 will be provided below.

The computing device 110 used by the tracking coordinator 102 may also include a database interface 114. The database interface 114 may also be a software module, as that term is described above. In one embodiment, the database interface 114 is simply a user interface for the database 112. In another embodiment, the database interface 114 takes the form of a dynamic web server that enables the database 112 to be accessed over the Internet. Additional details about the configuration and operation of various embodiments of the database interface 114 will be provided below.

The secondary computing devices 110b may be in communication with the primary computing device 110a over one or more networks 116. As used herein, a network 116 refers to any system that facilitates the transmission of data between the primary computing device 110a and one or more secondary computing devices 110b. Networks 116 are known to those skilled in the art. Examples of networks 116 include a local area network, a wide area network, a wireless network, the Internet, and the like.

The secondary computing devices 110b may include remote access software 118. The remote access software 118 allows a user of the secondary computing device 110b to search and/or update the database 112 through the database interface 114. Remote access software 118 is known to those skilled in the art. In one embodiment, the remote access software 118 is a web browser that requests web pages from a dynamic web server and displays them to a user of the secondary computing device 110b.

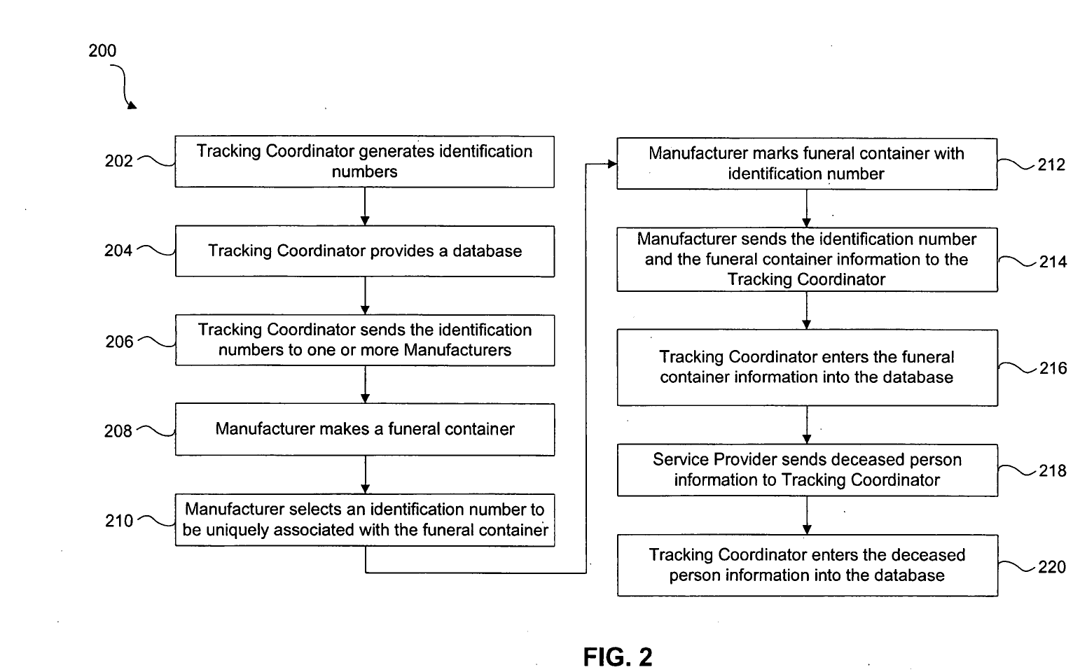

FIG. 2 is a flow diagram illustrating an embodiment of a method 200 for identifying and tracking funeral containers. The method 200 may begin when the tracking coordinator 102 generates 202 one or more identification numbers. Each identification number is designed to be uniquely associated with a funeral container. Details about various embodiments of the identification numbers, and various ways in which the identification numbers may be generated, will be provided below.

The tracking coordinator 102 may then provide 204 a database 112. The database 112 may be used to uniquely associate the identification numbers generated in step 202 with funeral containers made by funeral container manufacturers 104. As used herein, to “uniquely associate” an identification number with a funeral container means that (1) the identification number is associated with the funeral container, and (2) the identification number is not associated with any other funeral containers.

The tracking coordinator 102 may then send 206 the identification numbers generated in step 202 to one or more manufacturers 104. In one embodiment, the tracking coordinator 102 may electronically send 206 the identification numbers to the manufacturers 104. Those skilled in the art will appreciate the various ways in which electronic information may be transmitted to a remote location. For example, HTTP, FTP, e-mail, etc., may all be used to transfer information electronically. In another embodiment, the tracking coordinator 102 may send 206 the identification numbers to the manufacturers 104 through regular mail.

Typically, a manufacturer 104 who has received the identification numbers sent in step 206 is consistently making 208 funeral containers. At some point, the manufacturer 104 may select 210 one of the identification numbers received from the tracking coordinator 102 to be uniquely associated with one of the funeral containers made in step 208. The manufacturer 104 may then mark 212 the funeral container with the identification number. In one embodiment, this may involve engraving one or more metallic plates with the identification number, and then affixing the metallic plates to the funeral container. The metallic plates may be affixed to any suitable location on the exterior and/or the interior of the funeral container.

The method 200 may continue when the manufacturer 104 sends 214 the identification number and funeral container information to the tracking coordinator 102. The funeral container information describes the funeral container associated with the identification number, and may include the type of funeral container (e.g., casket, urn, etc.), the color of the funeral container, the model number of the funeral container, the material used to make the funeral container, etc. In one embodiment, the manufacturer 104 may electronically send the identification number and the funeral container information to the tracking coordinator 102 using, for example, standard e-mail software. In another embodiment, the manufacturer 104 may simply send the identification number and the funeral container information to the tracking coordinator 102 through regular mail. Once the tracking coordinator 102 receives the identification number and the funeral container information, the tracking coordinator 102 may then enter 216 the funeral container information into the database 112 in such a way that the funeral container information is uniquely associated with the identification number. In one embodiment, this may involve entering 216 the funeral container information into a record within the database 112 that includes the identification number.

At some point, the funeral container may be sold to a service provider 106. When the remains of a deceased person are to be placed inside the funeral container, the service provider 106 may send 218 deceased person information to the tracking coordinator 102. The deceased person information describes the deceased person whose remains are contained in the funeral container, and may include the deceased person's name, the deceased person's date and location of birth, the deceased person's date and location of death, etc. In one embodiment, the service provider 106 may electronically send the deceased person information to the tracking coordinator 102 using, for example, a web interface. In another embodiment, the service provider 106 may simply send the deceased person information to the tracking coordinator 102 through regular mail. Once the tracking coordinator 102 receives the deceased person information, the tracking coordinator 102 may then enter 220 the deceased person information into the database 112 in such a way that the deceased person information is uniquely associated with the identification number. In one embodiment, this may involve entering 220 the deceased person information into a record within the database 112 that includes the identification number.

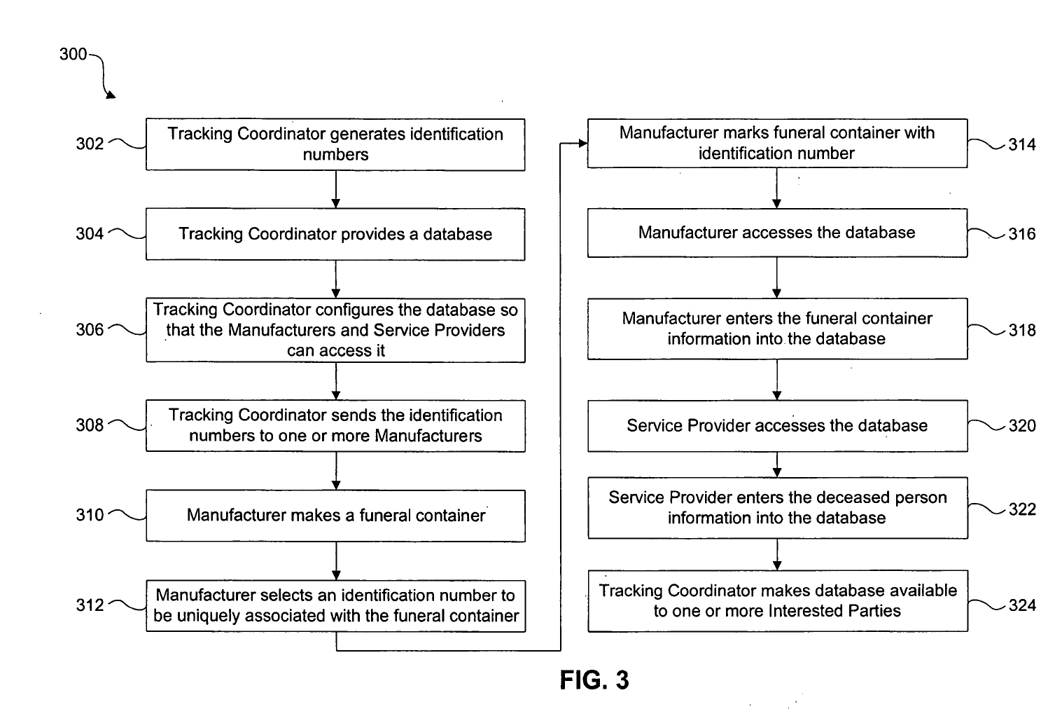

FIG. 3 is a flow diagram illustrating an alternative embodiment of a method 300 for identifying and tracking funeral containers. Steps 302 through 304 in the method 300 shown in FIG. 3 correspond to steps 202 through 204 in the method 200 shown in FIG. 2.

Once the tracking coordinator 102 provides 304 a database 112, the tracking coordinator 102 may then con FIG. 306 the database 112 so that one or more manufacturers 104 and one or more service providers 106 may access it 112. In one embodiment, this may involve providing a web site through which the manufacturers 104 and service providers 106 may access the database 112.

At this point, the tracking coordinator 102 may send 308 the identification numbers generated in step 302 to one or more manufacturers 104. As stated previously, a manufacturer 104 who has received the identification numbers sent in step 308 is typically making 310 funeral containers on a consistent basis. At some point, the manufacturer 104 may select 312 one of the identification numbers received from the tracking coordinator 102 to be uniquely associated with one of the funeral containers made in step 310. The manufacturer 104 may then mark 314 the funeral container with the identification number, as described previously.

The manufacturer 104 may then access 316 the database 112 provided 304 by the tracking coordinator 102. The manufacturer 104 may, for example, use the remote access software 118 to access the database 112 through the database interface 114. The manufacturer 104 may then enter 318 the funeral container information into the database 112 in such a way that the funeral container information is uniquely associated with the identification number. As described previously, this may involve entering the funeral container information into a record within the database 112 that includes the identification number.

As stated previously, the funeral container may at some point be sold to a service provider 106. When the remains of a deceased person are to be placed inside the funeral container, the service provider 106 may then access 320 the database 112. The service provider 106 may, for example, use the remote access software 118 to access the database 112 through the database interface 114. The service provider 106 may then enter 322 the deceased person information into the database 112 in such a way that the deceased person information is uniquely associated with the identification number. In one embodiment, this may involve entering the deceased person information into a record within the database 112 that includes the identification number.

The tracking coordinator 102 may also make 324 the database 112 available to one or more interested parties 108. In one embodiment, the interested parties 108 may be relatives or friends of a deceased person who wish to find out information about where the deceased person is buried. In another embodiment, the interested parties 108 may include one or more members of the media who wish to compile statistics about the funeral container industry. In yet another embodiment, the interested parties 108 may be one or more government agencies who have regulatory authority over the funeral container industry. Those skilled in the art will recognize numerous additional interested parties 108 who would like to have access to the information provided in the database 112. In one embodiment, making 324 the database 112 available to one or more interested parties 108 involves providing a web site through which the interested parties 108 may access the database 112. In another embodiment, making 324 the database 112 available simply involves sending information contained in the database 112 to the interested parties 108, either electronically and/or through regular mail.

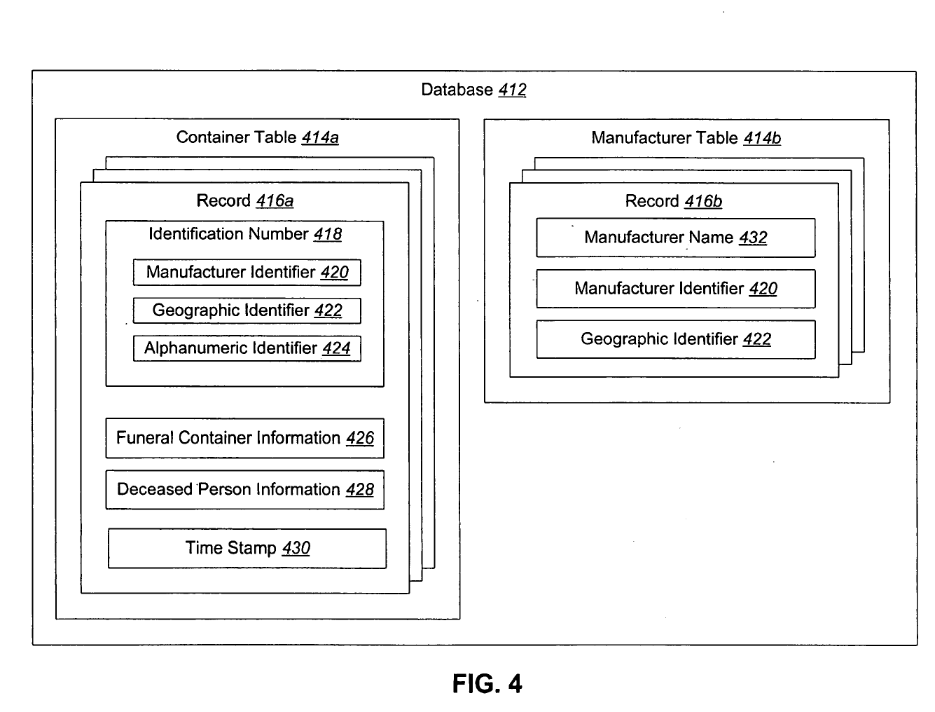

FIG. 4 is a block diagram illustrating an embodiment of a database 412. The database 412 may include one or more tables 414, and each table 414 may include one or more records 416. As shown, the embodiment of the database 412 shown in FIG. 4 includes a container table 414a and a manufacturer table 414b.

Each record 416a in the container table 414a may include an identification number 418. As shown, the identification number 418 may include a manufacturer identifier 420, a geographic identifier 422, and an alphanumeric identifier 424. The manufacturer identifier 420, geographic identifier 422, and alphanumeric identifier 424 may each be a series of alphanumeric characters. The manufacturer identifier 420 may uniquely identify a particular manufacturer 104. The geographic identifier 422 may uniquely identify a geographic region (e.g., country, state, city, etc.) in which the manufacturer 104 is located. The alphanumeric identifier 424 may simply identify a particular funeral container made by the manufacturer 104; Of course, the identification number 418 shown in FIG. 4 is exemplary only. Those skilled in the art will recognize various additional configurations for the identification number 418.

Each record 416a in the container table 414a may also include funeral container information 426. As stated previously, the funeral container information describes the funeral container associated with the identification number 418, and may include the type of funeral container, the color of the funeral container, the model number of the funeral container, the material used to make the funeral container, etc.

Each record 416a in the container table 414a may also include deceased person information 428. As stated previously, the deceased person information 428 describes the deceased person whose remains are contained in the funeral container corresponding to the funeral container information 428. The deceased person information 428 may include the deceased person's name, the deceased person's date and location of birth, the deceased person's date and location of death, etc.

Each record 416a in the container table 414a may also include a time stamp 430. The time stamp 430 may indicate the date and time when the record 416a was created.

As stated previously, the database 112 may also include a manufacturer table 414b. Each record 414b in the manufacturer table 414b may include a manufacturer name 432, i.e., the name of a manufacturer 104. Each record 416b may also include the manufacturer identifier 420 and the geographic identifier 422 associated with the manufacturer name 432.

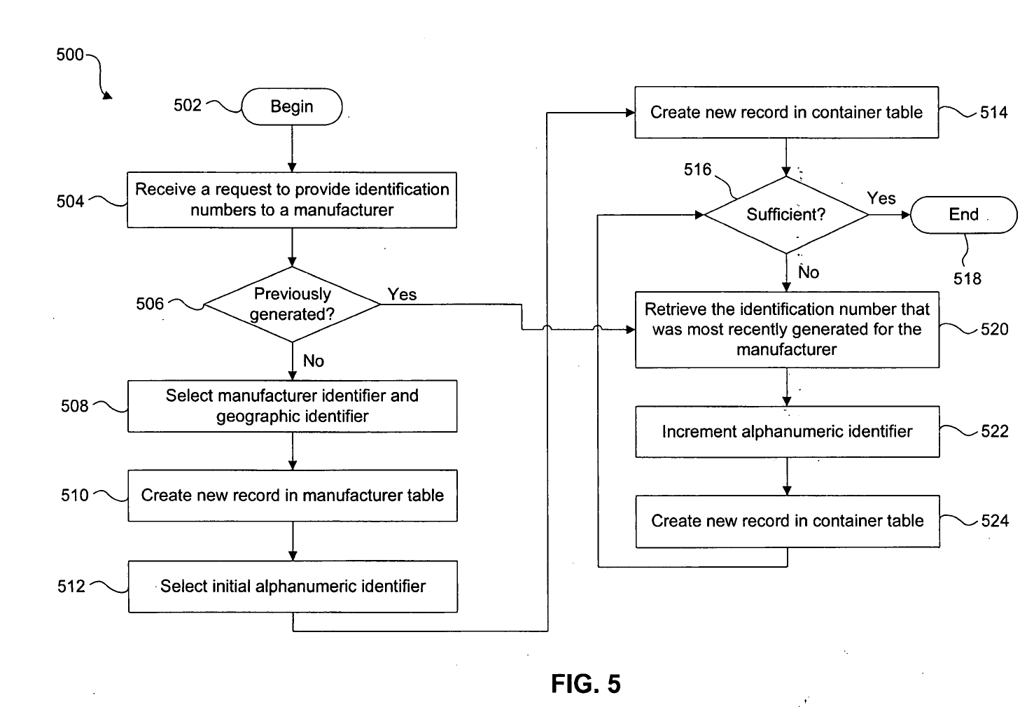

FIG. 5 is a flow diagram illustrating an embodiment of a method 500 for generating 202 one or more identification numbers 418. The method 500 illustrated in FIG. 5 may be implemented by the tracking coordinator 102. The tracking coordinator 102 may use one or more software modules, such as the database 112 and the database interface 114, to carry out various steps in the method 500.

The method 500 may begin 502 when the tracking coordinator 102 receives 504 a request to provide identification numbers 418 to a manufacturer 104. The tracking coordinator 102 may then determine 506 whether identification numbers 418 have previously been generated for the manufacturer 104. In one embodiment, this may involve searching the manufacturer table 414b in the database 412 for a particular manufacturer name 432.

If identification numbers 418 have not been previously generated for the manufacturer 104, the tracking coordinator may then select 508 a manufacturer identifier 420 and a geographic identifier 422. In an alternative embodiment, the manufacturer 104 may be allowed to choose the manufacturer identifier 420 and the geographic identifier 422. As stated previously, the manufacturer identifier 420 may uniquely identify a particular manufacturer 104. In one embodiment, the manufacturer identifier 420 may be a shortened version of the manufacturer name 432. For example, if the manufacturer name 432 is “Quality Caskets, Inc.,” the manufacturer identifier 420 may be “QC.” The geographic identifier 422 may uniquely identify a geographic region in which the manufacturer 104 is located. For example, the geographic identifier 422 may be a state abbreviation (e.g., “TX”).

After selecting 508 the manufacturer identifier 420 and the geographic identifier 422, the tracking coordinator 102 may then create 510 a record 416b in the manufacturer table 414b in the database 412. The record 416b may include the manufacturer name 432 and the manufacturer identifier 420 and geographic identifier 422 selected in step 508.

The method 500 may then involve selecting 512 an initial alphanumeric identifier 424. In one embodiment, the initial alphanumeric identifier 424 may be the number “1,” to indicate that it 424 is the first identification number 418 generated 202 for the manufacturer 104. If the alphanumeric identifier 424 is to be a fixed length, one or more leading zeroes may be added (e.g., “00001”). Of course, those skilled in the art will recognize various additional configurations for the alphanumeric identifier 424.

The method 500 may then involve creating 514 a new record 416a in the container table 414a in the database 412. The new record 416a may include a new identification number 418. The new identification number 418 may include the manufacturer identifier 420 and geographic identifier 422 selected in step 508, and the alphanumeric identifier 424 selected in step 512. The new record 416a may also include a time stamp 430 indicating when the record 416a was created.

The method 500 may then involve determining 516 whether enough identification numbers 418 have been generated to satisfy the request. This may involve comparing the number of identification numbers 418 requested in step 504 with the number of identification numbers 418 generated thus far in the method 500. If enough identification numbers 418 have been generated, the method 500 ends 518. If not enough identification numbers 418 have been generated, the method 500 may then involve retrieving 520 the identification number 418 that was most recently generated for the manufacturer 104. In one embodiment, this may involve retrieving 520 the record 416a in the container table 414a that includes (1) an identification number 418 with the appropriate manufacturer identifier 420 and (2) the most recent time stamp 430. The method 500 may then involve generating a new alphanumeric identifier 424 by incrementing 522 the alphanumeric identifier 424 retrieved in step 520.

The method 500 may then involve creating 524 a new record 416a in the container table 414a in the database 112. The new record 416a may include a new identification number 418. The new identification number 418 may include the manufacturer identifier 420 and geographic identifier 422 associated with the manufacturer 104, and the alphanumeric identifier 424 generated in step 522. As before, the new record 416a may also include a time stamp 430 indicating when the record 416a was created. The method 500 may then involve returning to step 516 and proceeding as described above.

If in step 506 it is determined that identification numbers 418 have been previously generated for the manufacturer 104, the method 500 may involve advancing directly to step 520 and proceeding as described above.

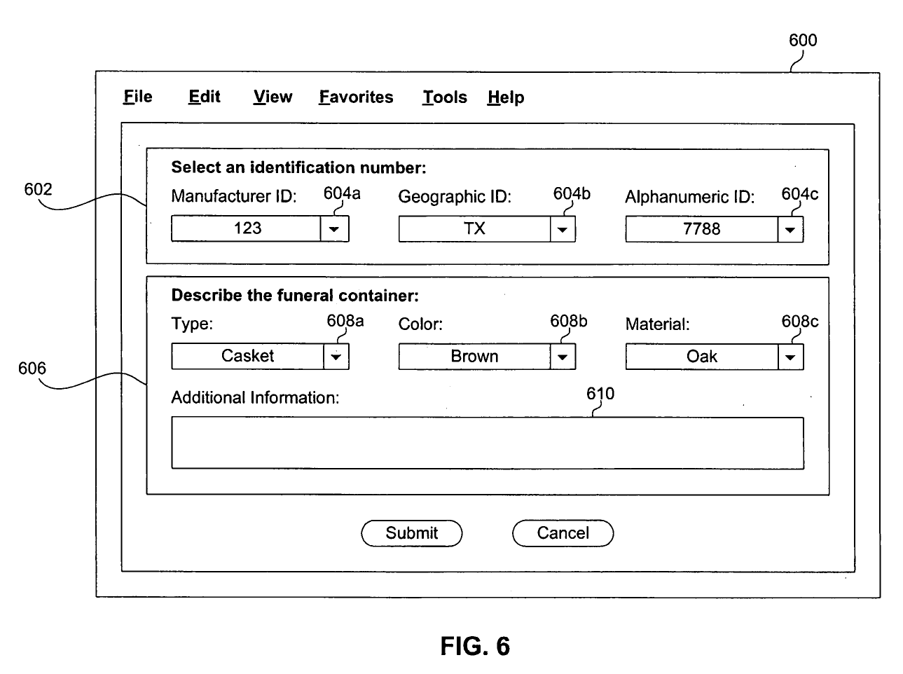

FIG. 6 illustrates an input screen 600 from an embodiment of a database interface 114. As stated previously, the database interface 114 may simply be a user interface for the database 112. In such an embodiment, the input screen 600 shown in FIG. 6 may be a part of that user interface. In another embodiment, the database interface 114 may be a dynamic web server that enables the database 112 to be accessed over the Internet. In such an embodiment, the input screen 600 may be a web page generated by the dynamic web server in response to a request from a web browser. Typically, the input screen 600 shown in FIG. 6 would be displayed to a tracking coordinator 102 or manufacturer 104 who is entering 318 funeral container information 426 into the database 112.

The input screen 600 may include a identification number window 602. The identification number window 602 may include a plurality of pull-down menus 604. One pull-down menu 604a may be used to select a manufacturer identifier 420, another pull-down menu 604b may be used to select a geographic identifier 422, and another pull-down menu 604c may be used to select an alphanumeric identifier 424.

The input screen 600 may also include a funeral container window 606. The funeral container window 606 may also include a plurality of pull-down menus 604. The pull-down menus 604 may be used to enter funeral container information 426. For example, one pull-down menu 608a may be used to specify the type of funeral container, another pull-down menu 608b may be used to specify the color of the funeral container, and another pull-down menu 608c may be used to specify the material used to make the funeral container. The funeral container window 606 may also include a text input box 610, which may be used to enter additional information about the funeral container that cannot be found among the pull-down menus 608.

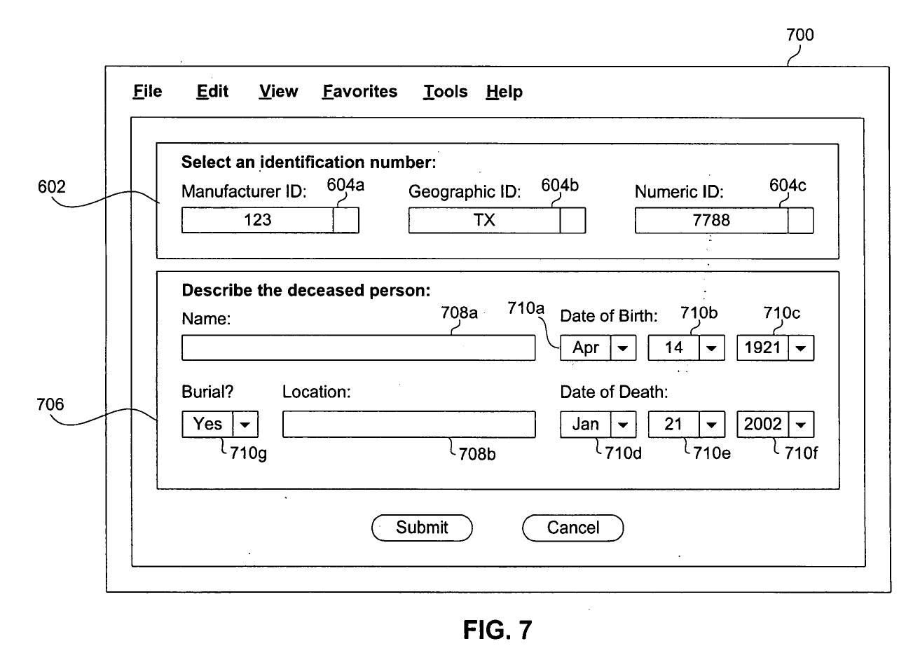

FIG. 7 illustrates another input screen 700 from an embodiment of a database interface 114. Typically, the input screen 700 shown in FIG. 7 would be displayed to a tracking coordinator 102 or service provider 106 who is entering deceased person information 428 into the database 112.

As shown, the input screen 700 includes an identification window 602 that is similar to the identification window 602 shown in FIG. 6 and described in connection therewith. The input screen 700 also includes a deceased person window 706 that includes a plurality of text input boxes 708. The text input boxes 708 may be used to enter deceased person information 428. For example, one text input box 708a may be used to enter the name of a deceased person, another text input box 708b may be used to enter the location where the deceased person's remains are to be kept, and so forth. The deceased person window 706 also includes a plurality of pull-down menus 710. The pull-down menus 710 may also be used to enter funeral container information 428. For example, one group of pull-down menus 710a-c may be used to enter the birth date of the deceased person, another group of pull-down menus 710d-f may be used to enter the death date of the deceased person, another pull-down menu 710g may be used to specify whether the deceased person is to be buried or cremated, and so forth.

Of course, the input screens 600, 700 shown in FIGS. 6 and 7 are exemplary only. Those skilled in the art will recognize a variety of different configurations for the input screens 600, 700.

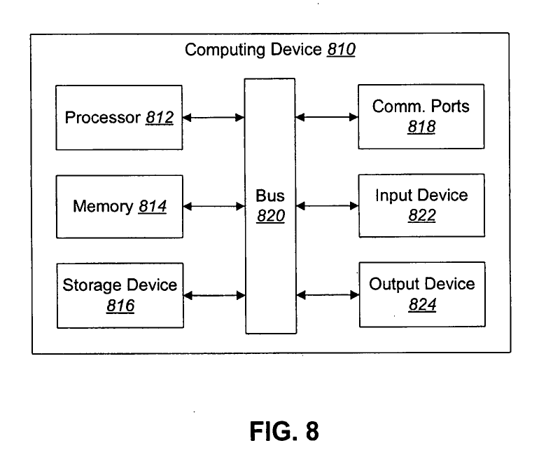

FIG. 8 is a block diagram of hardware components that may be used in an embodiment of a computing device 810. Many different types of computer systems may be used to implement the computing device 810 illustrated herein. The diagram of FIG. 8 illustrates typical components of a computing device 810 including a processor 812, memory 814, a storage device 816, and one or more communication ports 818. A bus 820 electronically couples all of the components in the computing device 810. Each of these components is known to those skilled in the art.

It will be appreciated by those skilled in the art that additional components may be included in the computing device 810. For example, several input devices 822 may be included, such as a keyboard, a mouse, a joystick, etc. In addition, several output devices 824 may be included such as a display screen, a printer, etc. Thus, those skilled in the art will appreciate that additional components may be added to the computing device 810 without detracting from the functionality to serve as a computing device 810.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for identifying and tracking a plurality of funeral containers, comprising:
generating a plurality of identification numbers;
providing a database for uniquely associating each identification number in the plurality of identification numbers with one of the plurality of funeral containers; and
sending the plurality of identification numbers to a funeral container manufacturer.

2. The method of claim 1, further comprising:
receiving an identification number selected from the plurality of identification numbers;
receiving funeral container information describing a funeral container; and
entering the funeral container information into the database in such a way that the funeral container information is uniquely associated with the identification number.

3. The method of claim 2, wherein the funeral container is marked with the identification number.

4. The method of claim 2, further comprising:
receiving deceased person information describing a deceased person whose remains are contained in the funeral container; and
entering the deceased person information into the database in such a way that the deceased person information is uniquely associated with the identification number.

5. The method of claim 1, further comprising configuring the database so that the funeral container manufacturer and a funeral service provider may access the database.

6. The method of claim 5, wherein configuring the database comprises providing a web site through which the funeral container manufacturer and the funeral service provider may access the database.

7. The method of claim 1, wherein each identification number in the plurality of identification numbers comprises a manufacturer identifier identifying the funeral container manufacturer.

8. The method of claim 7, wherein each identification number in the plurality of identification numbers further comprises a geographic identifier identifying a geographic region in which the funeral container manufacturer is located.
